(19) United States
(12) Patent Application Publication
(10) Pub. No.: US 2017/0019509 A1
(43) Pub. Date: Jan. 19, 2017

(54) MULTIFUNCTIONAL PHONE CASE

(71) Applicant: Andrew James Shaifer, New York, NY (US)

(72) Inventor: Andrew James Shaifer, New York, NY (US)

(21) Appl. No.: 15/211,977

(22) Filed: Jul. 15, 2016

Related U.S. Application Data
(60) Provisional application No. 62/193,362, filed on Jul. 16, 2015.

(51) Int. Cl. H04M 1/02; H04M 1/21

(52) U.S. Cl. CPC H04M 1/027; H04M 1/21; H04M 1/0235

(57) ABSTRACT

Multifunctional case for cell phones or tablet devices with flip, sliding, and adjustable lenses for viewing a screen and consumer needs is disclosed. It gives the consumer various ways of being able to solve the copious daily need for reading glasses.

### CROSS REFERENCE TO RELATED APPLICATION

This application claims priority from U.S. Patent Application No. 62/193,362 filed Jul. 16, 2015 and entitled “Multifunctional Phone Case with Flip, Sliding, Adjustable Lens for Viewing Phone Screen and Consumer Needs,” which is incorporated entirely herein by reference.

### BACKGROUND OF THE INVENTION

Technical Field

This invention relates to cases for cell phones and tablet devices. In particular, the invention relates to a multifunctional smartphone or tablet case with a multi-position lens for viewing the display screen. The adjustable, multi-position lens enables users to see their phone or other display screen, or read labels, without the use of reading glasses.

State of the Art

The display screens on smartphones, other cellular telephones, and some tablet devices are often difficult for persons with a degree of visual impairment, including presbyopia, to see clearly without reading glasses. Simply put there is nothing in the current eye care field which is easy to use and immediately available. Reading glasses are frequently lost and need to be replaced constantly. Additionally, even something that covers the iPhone or iPad does not have a multifunctional purpose.

What is needed, therefore, is an adjustable, multi-function visual aid for reading cell phone and tablet screens.

### SUMMARY OF EMBODIMENTS

Disclosed is a multifunction cell phone case comprising a body; a front cover hingedly coupled to the body; a sliding member adjustably coupled to the front cover; and a lens coupled to the sliding member, wherein the lens is adjustably positioned with respect to the body.

The foregoing and other features and advantages of the present invention will be apparent to those of ordinary skill in the art from the following more particular description of the invention and its embodiments, and as illustrated in the accompanying drawing figures.

### BRIEF DESCRIPTION OF THE DRAWINGS

FIG. 1 is a left side view of a multifunctional phone case with a phone inserted;

FIG. 2 is an additional left side view of a multifunctional phone case with a phone inserted;

FIG. 3 is a left side view of a multifunctional phone case with a phone inserted and a partially deployed lens;

FIG. 4 is an alternative left side view of a multifunctional phone case with a phone inserted and a partially deployed lens;

FIG. 5 is an alternative left side view of a multifunctional phone case with a phone inserted and a partially deployed lens in an alternative position;

FIG. 6 is an alternative left side view of a multifunctional phone case with a phone inserted and a partially deployed lens in a different alternative position;

FIG. 7 is an alternative left side view of a multifunctional phone case with a phone inserted and a partially deployed lens in a different alternative position;

FIG. 8 is an alternative left side view of a multifunctional phone case with a phone inserted a partially deployed lens in a different alternative position;

FIG. 9 is a front view of a multifunctional phone case with a phone inserted; and

FIG. 10 is a bottom view of a multifunctional phone case with a phone inserted.

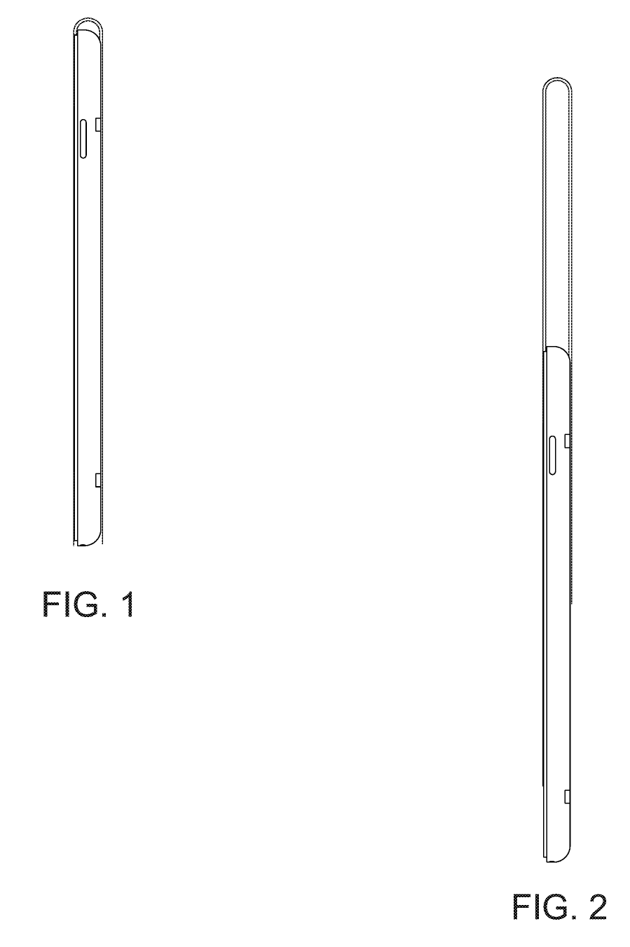

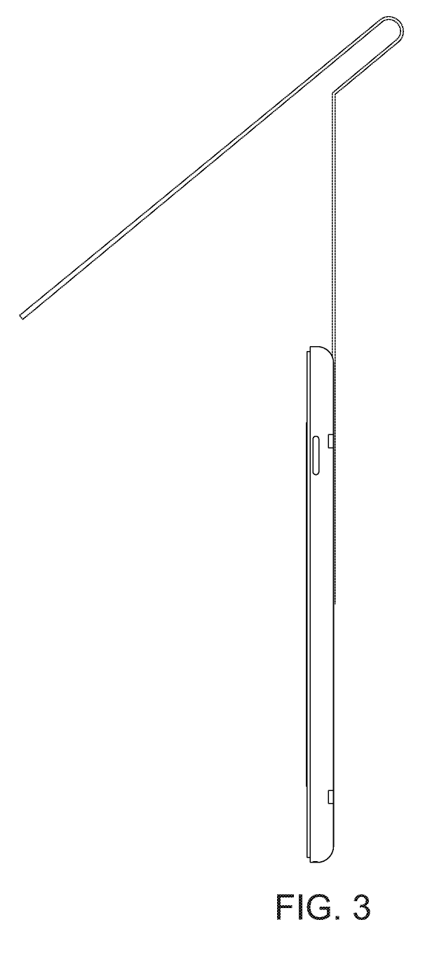

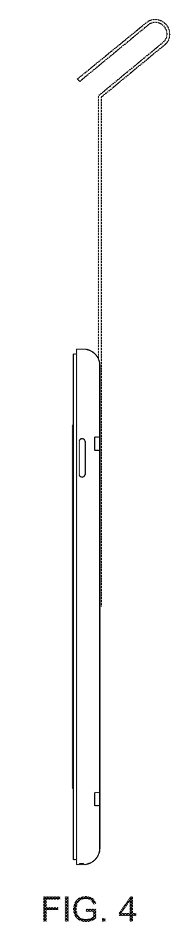

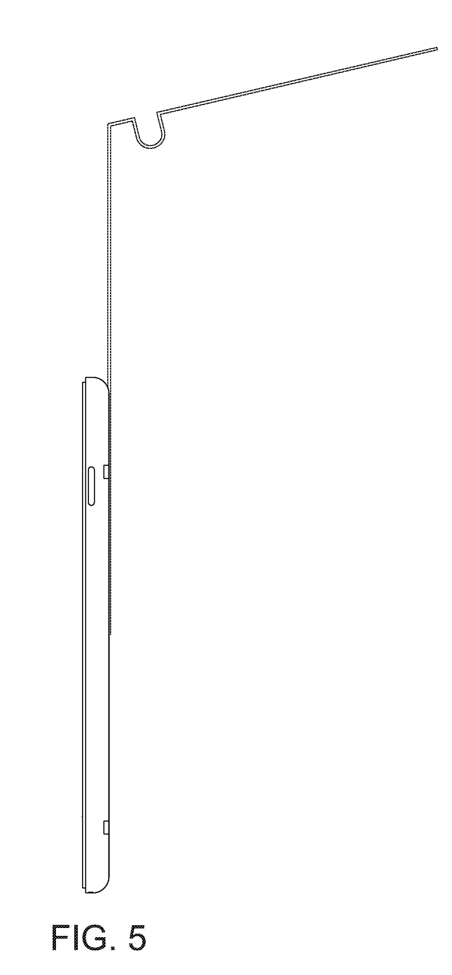

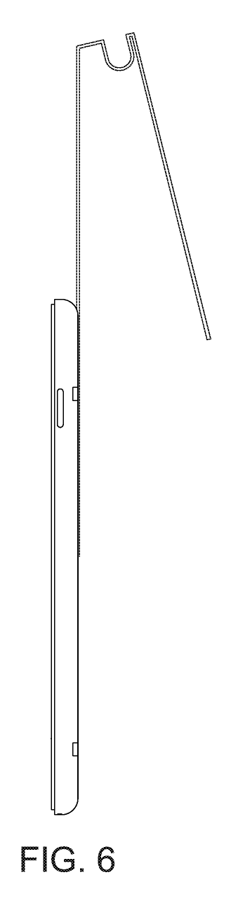

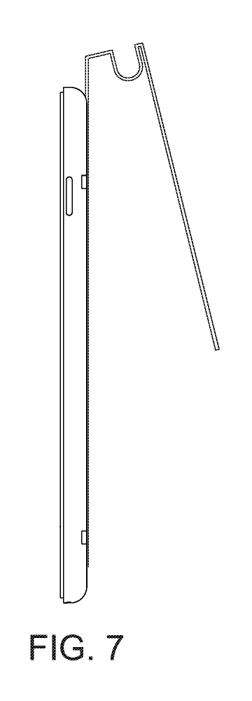

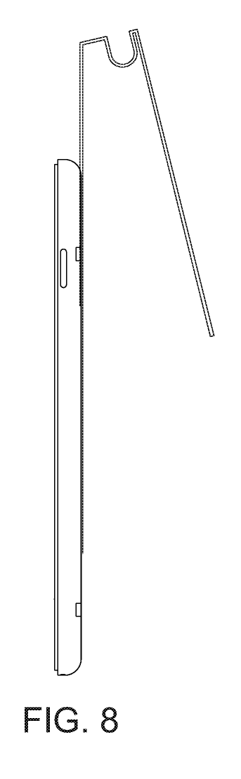

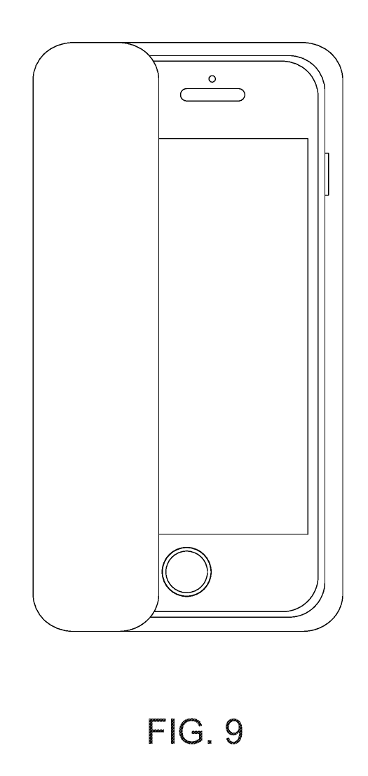

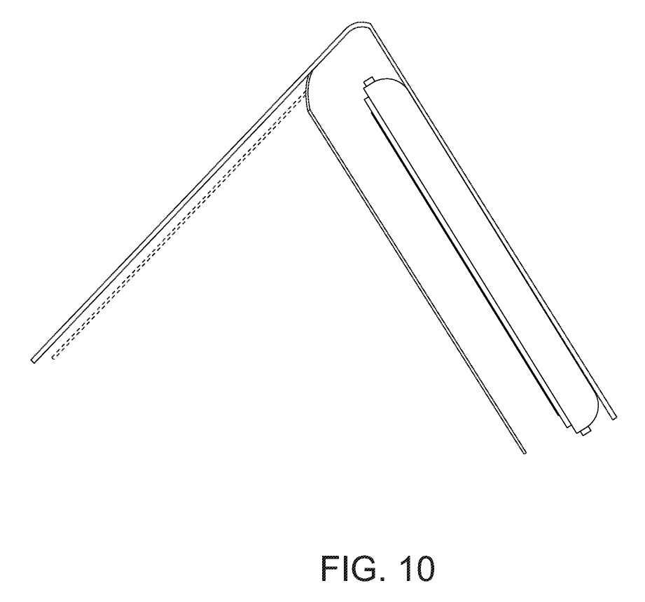

### DETAILED DESCRIPTION OF EMBODIMENTS OF THE INVENTION

As stated above, the subject invention enables users to see their phone screen or read labels without the use of reading glasses. The invention resolves the problem where those with a degree of visual impairment, including presbyopia, cannot clearly see their phone screen or other mobile computing device without reading glasses.

Multifunctional in purpose, the invention, in some embodiments, is used for cell phones and tablet devices with a lens that comes in the protective case and is able to flip out of the case and sit on or extend over the screen.

The lens prescription is adjustable for the user and also slides away from the screen to read things not on a cell phone or tablet device, such as labels in supermarkets and other daily consumer needs.

The claimed invention differs from the prior art. In some embodiments, the invention is a part of one's cell phone or tablet case; therefore it is less likely to be lost, whereas reading glasses are often easily lost by a person who requires them to read their cell phone or tablet device. Additionally, the invention can be multifunctional, in some embodiments, in that the lens within the case is able to be used for reading one's cell phone or tablet device, but also assists the user in reading simple daily consumer products that also require reading glasses.

Reading glasses are both an extra item to carry and the ability to lose the reading glasses is a concern every time they are needed

The subject invention gives the consumer various ways of being able to solve the copious daily need for reading glasses.

Embodiments of the present invention include a case with extractable hinge(s) for the lens to enable it to cover the cell phone or tablet device as well as be convertible for reading consumer products. The phone case contains a lens that uses the hinge to access the lens with the screen or consumer product that one desires to read.

By being a part of one's protective cell phone or tablet device case, the lens and hinge are able to work easily in conjunction with the cell phone or tablet device and make viewing needs of the user less cumbersome than procuring their reading glasses for each and every usage.

Using acrylics and polymers that are used in producing an eyeglass lens, in some embodiments. In some embodiments, the lens will be extremely thin to meld with the protective case. The case is made from either leather or rubber compounds, in some embodiments, however this is not meant to be limiting. The hinge, in some embodiments, is a basic hinge used on a smaller scale.

Acrylics and polymers are essential to this along with rubber and leather and the items that are used in making a hinge, in some embodiments. In some embodiments, the lens uses modern eyeglass thinning lens technology and is slimmer and sleeker so that its not overbearing for the user.

The elements cannot be shuffled to serve the aforementioned multifunctional uses of the invention.

Extremely user friendly, the protective phone case and lens are able to be guided from the case to the screen and then with the adjustment sliding capability be able to be specific to one's prescriptive needs. Further the lens can flip to the side of the case to read various consumer products.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

What is claimed is:

1. A multifunction cell phone case comprising:
a body;
a front cover hingedly coupled to the body;
a sliding member adjustably coupled to the front cover; and
a lens coupled to the sliding member, wherein the lens is adjustably positioned with respect to the body.
